(19) United States
(12) Patent Application Publication
(10) Pub. No.: US 2010/0018139 A1
(43) Pub. Date: Jan. 28, 2010

(54) REINFORCED PLASTIC PROFILE FOR WINDOW, DOOR AND FACADE ELEMENTS

(75) Inventor: Erwin Brunnhofer, Fuldabruck (DE)

Correspondence Address: J-TEK LAW PLLC, 601 Pennsylvania Avenue, NW, Suite 900, South Building, Washington, DC, 20004, US

(73) Assignee: TECHNOFORM CAPRANO UND BRUNNHOFER GMBH & CO. KG, FULDABRUCK (DE)

(21) Appl. No.: 12/519,129

(22) PCT Filed: Dec. 14, 2007
(86) PCT No.: PCT/EP07/11027

§ 371 Date: Aug. 3, 2009

(30) Foreign Application Priority Data
Dec. 15, 2006 (DE) 10 2006 059 854.7

(51) Int. Cl. E06B 3/22

(52) U.S. Cl. 52/204.5

(57) ABSTRACT

A reinforced plastic profile for window, door and facade elements has a plastic profile body, which extends in a longitudinal direction, and at least one reinforcement element. The plastic profile body includes at least one receptacle guide extending in the longitudinal direction. The at least one reinforcement element is connected with the plastic profile body in a longitudinally-fixed manner by foam-filling the receptacle guide with the reinforcement element positioned therein. As a result the reinforcement element is precisely positioned relative to the outer geometry of the plastic profile body.

The present invention relates to a reinforced plastic profile for window, door and facade elements.

Window systems generally comprise a wing profile and a frame profile, wherein the wing is glazed and the frame is connected with the building shell (brickwork). These profiles are, for example, made of wood, steel, aluminum, plastics, or combinations of these materials. The variety of competing materials is based in part on tradition; however, the factors thermal properties, wind-resistance, maintenance costs, aesthetic impression, and price are also important for the selection of the material.

Extruded plastic hollow profiles for windows and doors are known in the prior art (e.g. DE 33 19 144 A1), in which the hollow profile part has a plurality of hollow chambers extending along the hollow profile part. Typically, such hollow profile parts are made of rigid PVC. One or more of the internal chambers may be filled with foamed plastic (see also EP 1 154 115 B1). The corner connection of window frames made from such hollow profile parts is produced by welding or by the use of corner connectors, which are adhered in place. Window systems (e.g. under the designation Corona CT 70 Plus) having foam-free plastic hollow profiles with a plurality of hollow chambers and conventional steel reinforcements are offered by the window manufacturer Schüco of Bielefeld, Germany, wherein steel reinforcement profiles are inserted into hollow chambers. The steel reinforcement profiles are also used for anchoring of fittings. In these window systems, the attachment of decorative external covers made of aluminium is possible.

Profile members made of plastic foam for window elements are known from DE 201 05 876 U1, DE 32 42 909 A1 and WO 97/22779 A1, respectively, in which insulating frames (DE 201 05 876 U1) or profile parts made of metal (DE 32 42 909 A1) or also profile parts made of wood or plastics (WO 97/22779 A1) are connected in different ways with the core made of plastic foam. In the polyurethane-foam core known from DE 201 05 876 U1, separate core profiles are provided in the polyurethane-profile.

A plastic profile member for window and door elements is known from EP 1 705 334 A2, wherein metal profile parts are adhered or rolled-in on both outer sides of the plastic profile part, which outer sides form the interior and exterior sides of the window and door elements.

Furthermore, aluminum window, door and facade elements, which are comprised of weather-side and interior-side aluminum profiles made of aluminum-plastic composite profiles, are known, which aluminum profiles are friction-fit/form-fit connected to plastic profiles. In the manufacturing of the components, the profiles are assembled into frames, wherein the corners are mechanically connected via inserted corner connectors.

Moreover, composite window, door and facade elements, which are comprised of weather-side and interior-side profiles made of compound profiles using freely-selectable materials, are known, which materials are friction-fit/form-fit connected to plastic profiles (EP 1 555 376 A1).

DE 197 43 381 A1, DE Laid-open publication 27 52 463, and GB 2 153 889 A each disclose a reinforced plastic profile for windows, etc., wherein a reinforcement element is foam-embedded in a hollow space in a predetermined position. DE 1 983 744 U, DE 203 21 232 U1, and DE 196 34 907 A1 each disclose further reinforced plastic profiles for windows, etc.

It is an object of the invention to provide an improved reinforced plastic profile for window, door and facade elements, and a composite profile assembly having such a reinforced plastic profile for window, door and facade elements. This object is achieved by a reinforced plastic profile according to claim 1, a method for manufacturing a reinforced plastic profile according to claim 11, and a window, door and facade element according to claim 12, respectively.

Further developments of the invention are provided in the dependent claims.

A profile system for windows, doors and facades is made possible by the invention, wherein hollow profiles made of plastic are used and reinforcements are installed in the hollow profiles in a positionally-precise and longitudinally-fixed manner.

The profiles may be connected via corner connectors to structural elements, such as window, door and facade elements, in a manner analogous to aluminum windows. For the manufacture of the plastic profiles made of, e.g., rigid PVC, PA, PET, PBT, PA/PPE, ASA (reinforced or not reinforced) or other materials, a manufacturing method is used that calibrates both the outer contour and the inner contour in a positionally-precise manner.

By calibrating in a positionally-precise manner, a precision can be ensured, with which the inserted and attached (e.g., adhered) reinforcements are positioned relative to the outer contour with the necessary small tolerance.

The invention offers several advantages for designing the properties of window, door and facade elements, in which the reinforced plastic profile are used.

a) Thermal Properties

The thermal rating may be determined by the choice of the constructional depth of the plastic hollow profiles and by the configuration, size, and distribution of the internal hollow spaces, as well as their foam filling.

b) Mechanical Properties

The mechanical properties such as torsion resistance, etc. may be determined by the constructional depth (i.e., the distance between the weather-side and interior-side reinforcements) and by the configuration, size and cross-sectional area of the reinforcements.

c) Cross Section

Undercuts and geometries of arbitrary complexity for accommodating fitting and locking elements, seals, etc., are made possible in the cross section of the profiles by the use of the plastic hollow profiles.

d) Surface and Color Design

The surface and color design may also be varied in many ways for differing designs of the weather side and the interior side by the choice and the coloration of the plastics and by the use of decorative elements.

One embodiment of the inventive system comprises a plastic hollow profile having one or more metal reinforcements, which are preferably precisely positioned in the interior space using adapter fittings, and are adhered therein in a longitudinally-fixed manner using a foamable thermosetting resin, thereby providing a high flexural rigidity for the hollow profile as a whole.

The plastic frame profile and the plastic wing profile, for example, each include a hollow profile having one or more chambers, wherein one or more narrow-tolerance recesses for metal reinforcements are preferably formed on an inner chamber.

The outer contour of the hollow profile is determined by the required functions, such as e.g.:

a) sealing receptacles, sealing stops, fitting receptacles in the closing plane;
b) block surfaces, functional grooves for the glass guide rail, glass seal recesses, and drainage for the glazing;
c) grooves, window sill stop, receptacles for sealing films, etc. for the building shell (brickwork); and
d) glossy, colored and weather-proof surfaces of the hollow profile and/or latches for mounting decorative profiles made of plastic, wood, aluminum or stainless steel (extruded or rolled) for the exterior and interior sides.

The reinforcement preferably comprises extruded aluminum hollow profiles having an inner contour for accommodating corner connectors (as is usual for aluminum windows) and an outer contour having positioning surfaces for precisely fixing the position in the plastic hollow profile.

The reinforcements may have additional functions, such as are necessary for the threaded connection of T-joints or fittings.

The plastic hollow profiles are preferably comprised of reinforced materials, e.g. PA 66 GF, and include functional elements on the outer contour, e.g., for accommodating fitting and locking elements, seals, glass guide rails, decorative covers and the like.

The plastic hollow profiles for windows, doors and facades achieve a satisfactory static bearing capacity due to the reinforcement profiles, which are connected in a longitudinally-fixed manner and are preferably formed of aluminum. The reinforcement profiles preferably include a portion suitable for accommodating corner connectors. Preferably, functional portions for accommodating fitting and locking elements, seals, glass guide rails may be integrated into the plastic hollow profile. Preferably, the reinforcement profiles may be covered with decorative covers. The plastic hollow profiles fulfil application-specific mechanical requirements by selecting a suitable plastic, e.g. PA 66 GF.

Additional features and advantages will become apparent from the description of the embodiments with respect to the figures, wherein:

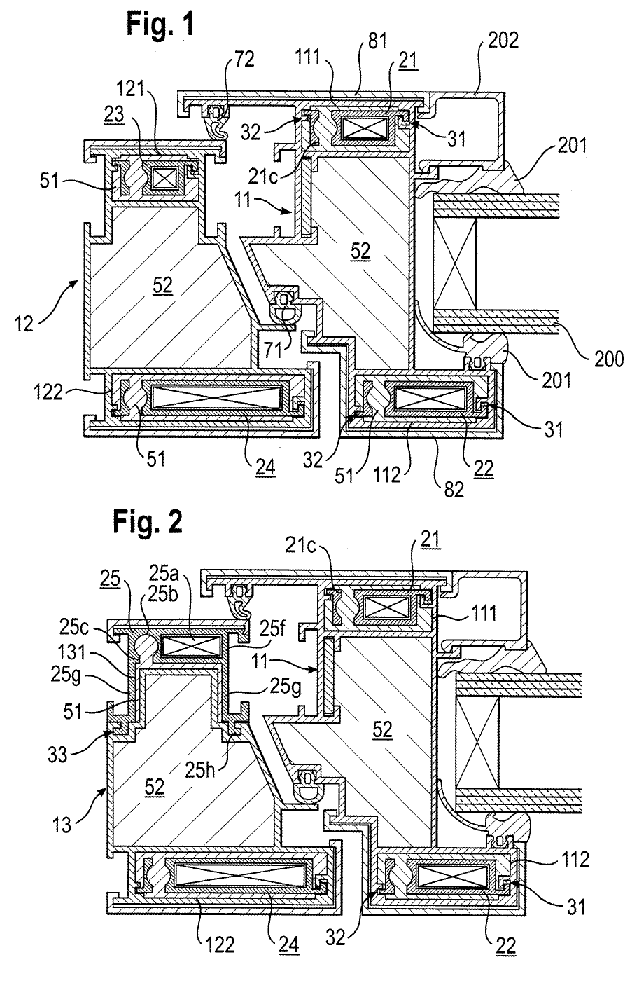

FIG. 1 shows a cross-sectional view perpendicular to the longitudinal direction of a reinforced plastic profile according to a first embodiment of the invention;

FIG. 2 shows a cross-sectional view perpendicular to the longitudinal direction of a reinforced plastic profile according to a second embodiment of the invention;

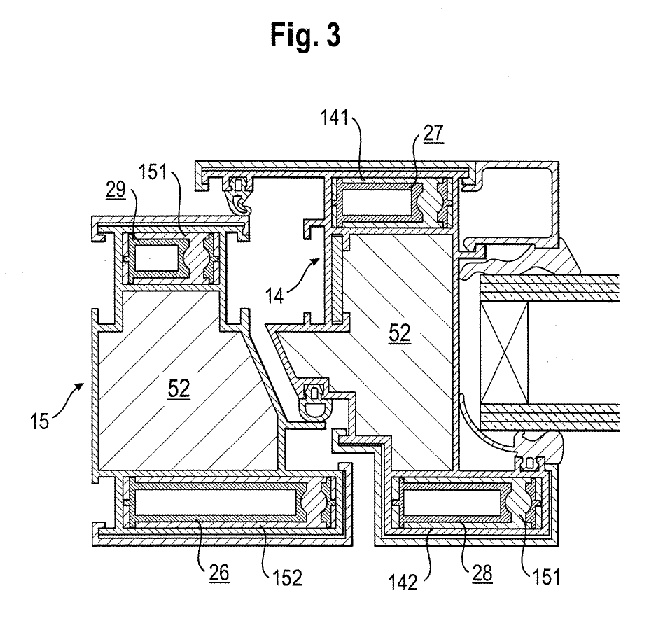

FIG. 3 shows a cross-sectional view perpendicular to the longitudinal direction of a reinforced plastic profile according to a third embodiment of the invention; and

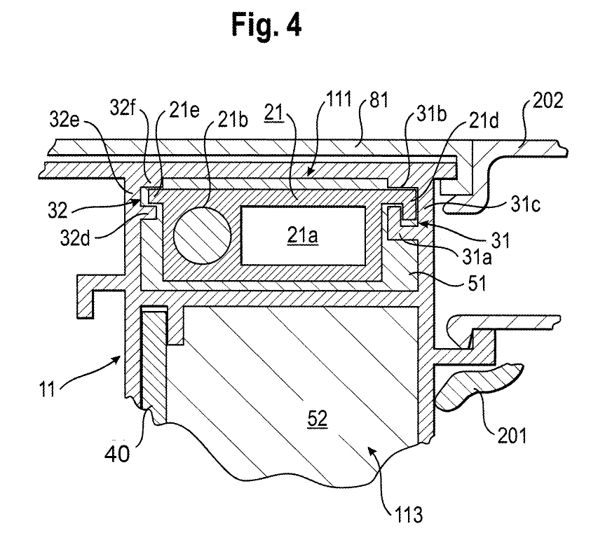

FIG. 4 shows an enlarged view of a receptacle and a reinforcement element.

A first embodiment of the invention will be described with reference to FIG. 1 and FIG. 4. Profile parts, when they are components a frame profile and a window wing profile, are shown in FIG. 1 in the cross section perpendicular to the longitudinal direction of the respective profile parts. On the right hand side of FIG. 1, a plastic hollow profile 11 is shown in the cross section perpendicular to the longitudinal direction; the plastic hollow profile 11 forms a part of a window wing. In a known way, a double-glazed pane 200 may be held on/in the frame of the window wing via sealing/mounting elements 201, which may also have a different shape, and a glass guide rail 202.

The plastic hollow profile 11 has a hollow chamber 111 on the side shown at the top of FIG. 1 (room side); the hollow chamber 111 is formed as a receptacle for a reinforcement element 21. Receptacle guides 31, 32 are formed in the receptacle 111, which is formed as the hollow chamber. The receptacle guide 31 comprises a recess undercut with respect to the interior space of the receptacle 111. This undercut recess may, for example, be defined by a rail 31a, which has a hook-shape in cross section, and an opposing side wall 31b, as well as an outer wall 31c of the receptacle 111, as can be seen best in FIG. 4. The receptacle guide 32 is formed on the opposite side of the receptacle 111 as a recess that opens to the interior of the receptacle 111. This recess is defined by a straight bar 31d, which projects perpendicularly from the corresponding side wall 32e of the receptacle 111, and an opposing wall 32f.

The aluminum hollow profile 21 includes a hollow chamber 21a that is enclosed by the aluminum hollow profile on all sides in the cross section perpendicular to the longitudinal direction. The aluminum hollow profile 21 further has a channel 21b extending through the hollow profile in the longitudinal direction, as shown in FIGS. 1 and 4. This channel is connected with the interior space of the receptacle 111 surrounding the aluminum hollow profile 21 via several passages 21c (see FIG. 1).

The aluminum hollow profile 21 further includes a projecting rail 21d. The rail 21d is formed as a rail that is hook-shaped in cross section, which rail has a shape that is complementary to the undercut recess of the receptacle guide 31 (within predetermined tolerances). A projecting rail 21e is formed on the side of the aluminum hollow profile 21 opposite to the rail 21d and has a shape that is complementary to the recess of the receptacle guide 32 (within predetermined tolerances). The rails 21d and 21e are formed on the aluminum hollow profile 21 such that they cooperate with the receptacle guides 31, 32 to precisely guide and position the aluminum profile 21 when it is inserted into the receptacle 111 and the receptacle guides 31, 32, as shown clearly in FIG. 4.

The receptacle 111 having the aluminum hollow profile 21 inserted in the above-described manner is foam-filled with a foam 51. The foam 51 is hardening foam having a high density which fills up the interior space of the receptacle 111 surrounding the aluminum hollow profile 21 and the channel 21b and the passages 21c of the aluminum hollow profile 21. The introduction of the foam 51 will be described below with respect to the description of the manufacturing of the reinforced plastic profile.

The plastic profile 11 has a corresponding receptacle 112 on the side opposite to the receptacle 111 (the weather side); an aluminum hollow profile 22 is inserted into the receptacle 112. The receptacle 112 has corresponding receptacle guides 31, 32 which correspond to the receptacle 112 but have different external dimensions. Because the receptacle 112, the receptacle guides 31, 32, and the aluminum hollow profile 22 correspond to the above-described receptacle 111, the above-described aluminum hollow profile 21, and the above-described receptacle guides 31, 32, respectively, the description will not be repeated. Similarly, a high density foam 51 is provided in the receptacle 112 in a corresponding manner.

The plastic hollow profile 11 further includes a hollow chamber 113. Preferably, another reinforcement element 23 is provided in the hollow chamber 113, if necessary, in a positionally-accurate manner relative to the external dimensions. The reinforcement element 23 serves to provide, e.g., a secure threadable connection of fittings to be mounted on the outer side of the plastic hollow profile. Preferably, the hollow chamber 113 is foam-filled at least partially (or completely) with a low density foam 52.

The cross section of the plastic hollow profile has a complex geometry with undercuts and the like for accommodating fitting and locking elements (not shown), seals 71, 72, 201, and other elements such as the window rail 202, and for mounting decorative elements 81, 82. The decorative elements 81, 82, for example, may be formed as aluminum covers that are clipped onto the profile. However, other materials such as stainless steel, wood, plastics, etc., are also possible for the decorative elements 81, 82.

The reinforced plastic profile of the above-described embodiment provides the advantages described in the description introduction with respect to the design of the thermal properties, the mechanical properties, the cross section and the surface and the color design. In the present embodiment, the aluminum hollow profiles 21, 22 are fixed in the plastic profile 11 by means of a high density foam 51. As a result, the plastic hollow profiles, in particular also their hollow chamber 21a, are positioned in a positionally-accurate manner relative to the outer contour of the plastic profile 11, because the outer contour of the plastic profile 11 and at least the receptacle guides 31, 32 relevant to the positioning of the aluminum hollow profiles 21, 22 are calibrated in a position-precise manner during the manufacture in a manner described below.

If reinforced plastic profiles of the type specified above are now connected using corner connectors, these corner connectors may be inserted into hollow chambers such as the hollow chamber 21a of the aluminum hollow profiles 21, 22, and the outer contours of the plastic hollow profiles also precisely align due to the position-precise calibration. Therefore, expensive post-processing when connecting using corner connectors may be minimized.

The frame profile shown in FIG. 1 having the plastic hollow profile 12 has a structure analogous to the already described plastic hollow profile 11, and thus it will be only briefly described here. Aluminum hollow profiles 23, 24 are inserted into receptacles 121, 122, which again have receptacle guides 31, 32, in a positionally-precise manner and are fixed using high density foam 51 in a positionally-precise manner relative to the outer contour of the plastic hollow profile 12 and, in addition, in a longitudinally-fixed manner. The plastic hollow profile has another hollow chamber that is foam-filled partially (or completely) with a low density foam 52. The remaining features correspond to those of the plastic hollow profile 11, so that the description will not be repeated.

In the following, a method for manufacturing the reinforced plastic hollow profile shown in FIG. 1 and FIG. 4 will be described. Methods and devices for manufacturing a hollow chamber profile are respectively described in EP 0 817 715 A1 and DE 199 21 458 A1, with which individual parts or the hollow chamber profile as a whole may be calibrated in a positionally-precise manner. The plastic hollow profiles 11, 12 of the first embodiment are manufactured using appropriate methods, wherein materials, which are color-fast, light-resistant, and/or weatherproof, are selected, according to particular requirements. In this manufacturing, the profiles are extruded and at least the outer surfaces and the inner surfaces provided for positioning the reinforcement are calibrated in a positionally-precise manner. As materials, rigid PVC, PA, PET, PPT, PA/PPE, ASA (reinforced or not reinforced), PA66GF, and other materials (also with or without reinforcement material) come into consideration.

The reinforcement parts are preferably manufactured by aluminum extrusion. The surface of the reinforcements may be better adapted for a connection with the foam by sand blasting or priming.

The mounting of the reinforcement elements is performed by inserting into the receptacle position provided for it. The longitudinally-fixed fixation of the reinforcement elements in the hollow profile can take place in a single foaming process, wherein the foam is introduced in the longitudinal direction through the channel 21b and the space of the receptacle surrounding the aluminum hollow profile, as well as through the passages 21c. As described above, high density (preferably 0.3 to 0.6 kg/l) foam (e.g., thermosetting plastics such as PU as a foam having a suitable density) is used for the longitudinally-fixed fixation of the reinforcement elements. Foams having low densities, which thus result in especially low heat conductivities, may be used for foam-filling of those portions, in which a longitudinally-fixed connection of reinforcement elements with the plastic hollow profile is not essential.

With the embodiment described above, arbitrary undercuttings at arbitrary positions of the profile are possible. The surface treatment of outer or inner coverings made of aluminum may be performed independently of a foaming process, which is advantageous, as the foam does not tolerate annealing temperatures. In addition to this advantage, the described embodiment provides a system having very good mechanical properties, wherein the reinforcement profiles may be utilized for corner connections using corner connectors, and, at the same time, the necessary post-processing is minimized. The embodiment further makes possible the use of foams having different densities, and the resulting optimization of heat conducting properties. It is particularly advantageous to divide the foaming portions such that high density foams are utilized for the longitudinally-fixed connection of the reinforcement, and a low density foam having particularly low lambda values is utilized for foam-filling the main hollow space.

Furthermore, the advantages described in the description introduction are provided.

In the following, a second embodiment is described with reference to FIG. 2. The embodiment shown in FIG. 2 differs from the first embodiment shown in FIG. 1 only in portions of the frame profile. As seen from the upper left side of FIG. 2, a plastic hollow profile 13, which forms the frame profile, has an embodiment of the receptacle 122, receptacle guides, and aluminum hollow profile 24 corresponding to the first embodiment on the side shown at the bottom of FIG. 1 (the weather side), which will not be further described here. No hollow chamber corresponding to the receptacle 121 is formed on the side at the top of FIG. 1; instead, a receptacle 131 for an aluminum hollow profile 25 is located on the outer side of the plastic hollow profile 13. The receptacle 131 has receptacle guides 33 having a shape corresponding to the receptacle guide 31.

An aluminum hollow profile 25 has a first portion 25f, in which a hollow chamber 25a corresponding to the hollow chamber 21a is formed. As in the aluminum profile 21, a channel 25b that also extends in the longitudinal direction is formed; however, the channel 25b has passages 25c only towards one side. This side is the side facing the plastic hollow profile 13 in the assembled state. Parallel protruding rails 25g having hook-shaped ends on the sides opposite the first portion 25f extend from the first portion 25f. Rails 25h also having a hook-shaped cross section extend from the hook-shaped ends and (similar to the receptacle guides 31 and the corresponding rails 21d of the first embodiment) are complementary to the undercut recesses of the receptacle guides 33 (with predetermined tolerances). The aluminum hollow profile is foam-attached to the plastic hollow profile 13 for the longitudinally-fixed and positionally-precise connection of the aluminum hollow profile 25 with the plastic hollow profile 13, wherein the foam is distributed in the longitudinal direction via the channel 25b and the passages 25c and the space between the aluminum hollow profile 25 and the plastic hollow profile 13. As in the first embodiment, a high density foam 51 is used for foam-attaching.

Obviously, a positionally-precise and longitudinally-fixed connection of the aluminum hollow profile 25 with the plastic hollow profile 13 using foam-attaching may be achieved by means of an appropriately-calibrated construction of the outer contour and the receptacle guides 33 of the plastic hollow profile 13.

A third embodiment is described with reference to FIG. 3. The third embodiment differs from the first embodiment in that no receptacle guides 31, 32 are provided in the receptacles 141, 142, 151, 152 of the plastic hollow profiles 14, 15. Instead of these, the aluminum hollow profiles 26, 27, 28, 29 have rails projecting on the outside of the aluminum hollow profiles which, in combination with the positionally-precise calibrated inner walls of the receptacles 141, 142, 151, 152, provide a precise guiding and positioning of the aluminum hollow profiles, which are inserted into the receptacles.

As in the first and second embodiments, the aluminum hollow profiles 26, 27, 28, 29 are fixed in the receptacles 141, 142, 151, 152 in a positionally-precise and longitudinally-fixed manner using high density foam 51.

The remaining features of the third embodiment correspond to the corresponding features of the first and second embodiments, so that the description will not be repeated.

In all embodiments, the method of manufacturing described with respect to the first embodiment may be used for manufacturing the plastic hollow profile. In all embodiments, in which the aluminum hollow profiles are foam-embedded or foam-attached, the method described with respect to the first and second embodiments, respectively, may be applied.

The plastic hollow profiles 11 to 15 described herein each have a single inner-disposed hollow chamber filled with low density foam 52. The plastic hollow profiles may have several chambers, which optionally may be fully or partially filled with high or low density foams, depending on the requirements to be fulfilled.

All embodiments have in common that the hollow chambers of the aluminum hollow profiles may be positioned in a positionally-precise manner such that the use of the corresponding hollow chambers for producing corner connections using corner connectors is available.

It will be apparent that, as an alternative or in addition to corner connectors, the corresponding connection may also be produced differently, for example, by welding the plastic hollow profiles. In this case, the longitudinally-fixed and positionally-precise arrangement of the aluminum hollow profiles is also advantageous, because, on the one hand, the mechanical properties may be improved, and, on the other hand, post-processing due to excess lengths or the like may be avoided.

The outer appearance of the described profiles may be fashioned, on the one hand, by suitably choosing the plastic materials, and, on the other hand, by attaching elements made of aluminum or other materials.

It is explicitly stated that all features disclosed in the description and/or the claims should be regarded as separate and independent of each other for the purpose of original disclosure as well as for the purpose of restricting the claimed invention, independent of the combination of features in the embodiments and/or the claims. It is explicitly stated that all indications of ranges or of groups of units disclose every possible intermediate value or sub-group of units for the purpose of original disclosure as well as for the purpose of restricting the claimed invention, especially also as a limit of a range indication.

1-12. (canceled)

13. A reinforced plastic profile for at least one of a window element, a door element and a facade element, comprising:
a plastic profile body extending in a longitudinal direction and having a first side and a second side opposite to the first side in a direction perpendicular to the longitudinal direction, the plastic profile body having at least two receptacle guides extending in the longitudinal direction, one of the at least two receptacle guides being formed on the first side and the other one of the at least two receptacle guides being formed on the second side; and
at least two reinforcement elements, wherein:
the outer surface of the plastic profile body and the receptacle guides are calibrated in a positionally-precise manner such that each of the receptacle guides is configured to precisely guide and position one of the reinforcement elements relative to the outer surface of the plastic profile body, and
the reinforcement elements are connected with the plastic profile body in a longitudinally-fixed manner by foam-attachment or by foam-embedding of the reinforcement elements, each of which is inserted into the respective receptacle guide and is positioned by the respective receptacle guide, wherein the reinforcement elements are precisely positioned relative to the outer geometry of the plastic profile body.

14. A reinforced plastic profile according to claim 13, wherein at least one reinforcement element is configured such that a connector is inserted into and securely connected with the reinforcement element to provide a corner connection for another reinforced plastic profile.

15. A reinforced plastic profile according to claim 14, wherein the plastic profile body has at least one hollow chamber extending in the longitudinal direction, the hollow chamber forming a receptacle for the at least one reinforcement element, wherein the hollow chamber includes one of the receptacle guides, which is configured to precisely guide and position the respective reinforcement element in the respective receptacle prior to being foam-embedded in the hollow chamber.

16. A reinforced plastic profile according to claim 15, wherein the plastic profile body has at least one second receptacle extending in the longitudinal direction and being positioned on the outer side of the plastic profile body, wherein a second receptacle guide is formed in the second receptacle and is configured to precisely guide and position a second reinforcement element prior to being foam-attached to the plastic profile body.

17. A reinforced plastic profile according to claim 16, wherein the reinforcement element is configured to at least one of accommodate and attach at least one of a fitting element and a locking element.

18. A reinforced plastic profile according to claim 17, wherein the reinforcement element includes:
at least one first portion configured for guiding and positioning in or on the plastic profile body, and
at least one second portion configured for accommodating and attaching a corner connector element, wherein the first and second portions have narrow tolerances relative to each other.

19. A reinforced plastic profile according to claim 18, wherein the reinforcement element has at least one third portion configured for introducing and distributing a means for connecting the reinforcement element in a longitudinally-fixed manner.

20. A reinforced plastic profile according to claim 19, wherein the means for connecting the reinforcement element comprises a foam having a density in the range of 0.3 to 0.6 kg/l, the foam adhering to the plastic profile body and the reinforcement element.

21. A reinforced plastic profile according to claim 20, wherein surfaces of the reinforced plastic profile provided for forming a weather side surface and an interior side surface of a window, door or facade element are configured such that decorative elements are attachable thereto.

22. A reinforced plastic profile according to claim 21, wherein the plastic profile body is formed as a plastic hollow profile body having at least one hollow chamber, and at least one of the hollow chambers of the plastic hollow profile body is at least partially filled with foam.

23. A reinforced plastic profile according to claim 13, wherein the plastic profile body has at least one hollow chamber extending in the longitudinal direction, the hollow chamber forming a receptacle for a reinforcement element to be foam-embedded, wherein the hollow chamber includes the corresponding receptacle guide for precisely guiding and positioning the reinforcement element to be foam-embedded in the hollow chamber.

24. A reinforced plastic profile according to claim 13, wherein the plastic profile body has at least one second receptacle extending in the longitudinal direction and being positioned on the outer side of the plastic profile body, wherein a second receptacle guide is formed in the second receptacle and is configured to precisely guide and position a second reinforcement element prior to being foam-attached to the plastic profile body.

25. A reinforced plastic profile according to claim 13, wherein the reinforcement element is configured to at least one of accommodate and attach at least one of a fitting element and a locking element.

26. A reinforced plastic profile according to claim 13, wherein the reinforcement element includes:
at least one first portion configured for guiding and positioning in or on the plastic profile body, and
at least one second portion configured for accommodating and attaching a corner connector element, wherein the first and second portions have narrow tolerances relative to each other.

27. A reinforced plastic profile according to claim 13, wherein the reinforcement element has at least one third portion configured for introducing and distributing a means for connecting the reinforcement element in a longitudinally-fixed manner.

28. A reinforced plastic profile according to claim 27, wherein the means for connecting the reinforcement element comprises a foam having a density in the range of 0.3 to 0.6 kg/l, the foam adhering to the plastic profile body and the reinforcement element.

29. A reinforced plastic profile according to claim 13, wherein the plastic profile body is formed as a plastic hollow profile body having at least one hollow chamber, and at least one of the hollow chambers of the plastic hollow profile body is at least partially filled with foam.

30. A reinforced plastic profile for at least one of a window element, a door element and a facade element, comprising:
a plastic profile body extending in a longitudinal direction and having a first side and a second side opposite to the first side in a direction perpendicular to the longitudinal direction, the plastic profile body having at least two receptacle guides extending in the longitudinal direction, one of the at least two receptacle guides being formed on the first side and the other one of the at least two receptacle guides being formed on the second side; and
at least two reinforcement elements, each reinforcement element being formed as a hollow profile having a hollow chamber enclosed on all sides in the cross section perpendicular to the longitudinal direction, wherein:
the outer surface of the plastic profile body and the receptacle guides are calibrated in a positionally-precise manner such that each of the receptacle guides is configured to precisely guide and position one of the respective reinforcement elements relative to the outer surface of the plastic profile body, and
the reinforcement elements are connected with the plastic profile body in a longitudinally-fixed manner by foam-attachment or by foam-embedding of the reinforcement elements, each of which is inserted into the respective receptacle guide and is positioned by the respective receptacle guide, wherein the reinforcement elements are precisely positioned relative to the outer geometry of the plastic profile body.

31. A structure comprising:
at least one structural element selected from a window, a door leaf and a facade, and
a reinforced plastic profile according to claim 30 connected to the at least one structural element.

32. A structure according to claim 31, wherein at least one reinforcement element is configured such that a connector is inserted into and securely connected with the reinforcement element to provide a corner connection for another reinforced plastic profile.
